(19) United States
(12) Patent Application Publication
(10) Pub. No.: US 2010/0113621 A1
(43) Pub. Date: May 6, 2010

(54) WATER IN OIL (W/O) EMULSION FORMED BY USING REVERSE VESICLE

(75) Inventors: Hiroshi HAYASHI, Tokyo (JP); Sadanao Okuda, Tokyo (JP); Masahiko Abe, Chiba (JP); Hideki Sakai, Chiba (JP)

Correspondence Address: FITCH, EVEN, TABIN & FLANNERY, P. O. BOX 18415, WASHINGTON, DC, 20036, US

(73) Assignee: RISO KAGAKU CORPORATION, Tokyo (JP)

(21) Appl. No.: 12/548,106

(22) Filed: Aug. 26, 2009

(30) Foreign Application Priority Data
Oct. 31, 2008 (JP) 2008-281301

(51) Int. Cl. B01F 17/00

(52) U.S. Cl. 516/29; 516/21

(57) ABSTRACT

A water-in-oil (W/O) emulsion which is stable even with a high water content is provided. The water-in-oil (W/O) emulsion is obtained by a three-phase emulsification using a reverse vesicle of an amphiphilic compound as an emulsifier. As the amphiphilic compound, a sucrose fatty acid ester is preferable, and a sucrose fatty acid ester with an HLB value of 6-12 is more preferable. The reverse vesicle can be prepared by mixing an amphiphilic compound with a non-polar solvent. The water-in-oil (W/O) emulsion can be formed by using the prepared mixture containing the reverse vesicle as an oil phase and adding water thereto for emulsification. As the non-polar solvent, an alicyclic hydrocarbon solvent such as cyclohexane is preferable. The reverse vesicle preferably has a particle diameter of not more than 1 μm.

### TECHNICAL FIELD

The present invention relates to a water-in-oil (W/O) emulsion formed by a three-phase emulsification method using a reverse vesicle as an emulsifier.

### BACKGROUND ART

In conventional emulsification methods using a surfactant, the basis for emulsification and dispersion was absorption of a surfactant on the interface between oil and water so as to lower the interfacial energy thereof. Thus, a large amount of emulsifier was required in order to lower interfacial tension.

Recently, a method for forming an emulsion by allowing nano particles of an amphiphilic compound to adhere to the oil interface with Van der Waals force has been proposed, wherein a vesicle self-organized in water is used as nano particles of the amphiphilic compound (Patent Documents 1-4).

In the above method using a vesicle, a stable oil-in-water (O/W) emulsion can be obtained, but a water-in-oil (W/O) emulsion can be obtained only with a very small amount range of the inner water phase.

On the other hand, it has been reported that an amphiphilic compound self-organizes a reverse vesicle which is a bilayer membrane facing hydrophilic groups toward each other in an oil contrary to the normal vesicle, but no research has been made for emulsion formation by a three-phase emulsification method using the reverse vesicle as an emulsifier (Non-Patent Documents 1-3).
Patent document 1: JP-A-2006-239666
Patent document 2: JP-A-2006-241424
Patent document 3: JP-A-2007-74909
Patent document 4: JP-A-2007-77178
Non-Patent Document 1: H. Kunieda, K. Nakamura, Fine Chemicals, Vol. 23, No. 4, p. 12-20 (1994)
Non-Patent Document 2: H. Kunieda, Polymers, Vol. 44, No. 9, p. 624 (1995)
Non-Patent Document 3: H. Kunieda, E. Ogawa, Hyomen, Vol. 34, No. 11, p. 24-32 (1996)

### DISCLOSURE OF THE INVENTION

### Problems to be Solved by the Invention

Under such circumferences, the present invention aims at providing a water-in-oil (W/O) emulsion which is stable even with a higher water content than a conventional water-in-oil (W/O) emulsion.

### Means for Solving the Problem

As a result of diligent researches under the above objects, the present inventors have found that a water-in-oil (W/O) emulsion which is stable even with a higher water content than before can be obtained by forming an emulsion with a three-phase emulsification method using a reverse vesicle of an amphiphilic compound as an emulsifier, and thus have completed the present invention.

That is, according to the present invention, there is provided a water-in-oil (W/O) emulsion comprising a reverse vesicle of an amphiphilic compound as an emulsifier.

### Effects of the Invention

The water-in-oil (W/O) emulsion of the present invention uses a reverse vesicle as an emulsifier, and thus a highly stable emulsion can be obtained, and a water content can be easily increased contrary to the conventional emulsion using a normal vesicle. Further, the water-in-oil (W/O) emulsion of the present invention has a three-phase emulsion structure comprising an oil phase forming a continuous phase, water phases scattering in the oil phase as dispersed phases which are surrounded by a plurality of reverse vesicles, and oil phases included in the reverse vesicles unlike the conventional two-phase emulsion, and furthermore, the water phases can intervene in a bilayer membrane of the reverse vesicles so as to contribute to stabilization of the reverse vesicles, and thus the highly stable water-in-oil (W/O) emulsion can be obtained even with a high water content. Also, the water-in-oil (W/O) emulsion of the present invention can use a wide range of emulsifiers with various HLB values, and thus provides great freedom of emulsion design unlike the conventional two-phase emulsion. Since the water-in-oil (W/O) emulsion of the present invention is low in emulsion viscosity even with a high water content, and also can contain various water-soluble or oil-soluble components in the reverse vesicles, it is expected to be applied to not only conventional uses but also various other uses.

### Best Mode for Carrying Out the Invention

Hereinafter, the present invention will be described in detail.

The “reverse vesicle” used in the present invention means a closed small sac formed by a bilayer membrane composed of amphiphilic compounds which are arranged to face their hydrophilic groups to each other, and details thereof are described in the above Non-Patent Documents 1 to 3.

The amphiphilic compound forming a reverse vesicle is not particularly limited as long as it forms a lamellar liquid crystal in a non-polar solvent, including, for example, sucrose fatty acid esters, tetraethylene glycol dodecyl ether, pentaethylene glycol dodecyl ether, lecithin, N^{α}-lauroyl arginine methyl ester hydrochloride, sodium bis(2-ethylhexyl) sulfosuccinate, didodecyldimethylammonium bromide, and diglyceryl monooleate. Of these, a sucrose fatty acid ester is preferable, an ester of sucrose with a higher fatty acid with 12-20 carbon atoms is more preferable, a sucrose fatty acid ester with an HLB value of 6-16 is further preferable, and a sucrose fatty acid ester with an HLB value of 6-12 is particularly preferable.

The non-polar solvent is not particularly limited as long as it allows an amphiphilic compound to form a reverse vesicle therein and maintains the formed reverse vesicle to be stable, including, for example, aliphatic or alicyclic hydrocarbon solvents with 6-20 carbon atoms. Of these, preferable are an aliphatic hydrocarbon solvent with 8-16 carbon atoms and an alicyclic saturated hydrocarbon solvent with 5-7 carbon atoms, and particularly preferable is an alicyclic saturated hydrocarbon solvent with 5-7 carbon atoms such as cyclohexane. Meanwhile, the non-polar solvent is also used as a solvent component of an oil phase in a water-in-oil (W/O) emulsion of the present invention.

A reverse vesicle can be prepared, for example, by mixing an amphiphilic compound in a non-polar solvent and subjecting the mixture to mechanical shaking. The mechanical shaking can be generated by a mixing device, an ultrasonic treatment device and the like. As the mixing device, a mixer such as a voltex mixer can be used. As the ultrasonic treatment device, a homogenizer can be used. Also, in some cases, an amphiphilic compound spontaneously forms a reverse vesicle by only diluting the amphiphilic compound with a non-polar solvent without mechanical shaking. In order to stabilize the reverse vesicle, a small amount of water or another kind of oil or amphiphilic substance can be added, and also temperature may be raised to about 40-90° C. during mixing. Whether the reverse vesicle is formed or not can be confirmed, for example, by an optical microscopic observation utilizing polarization or differential interference contrast or an electron microscopic observation in accordance with a freeze-fracturing method.

An amount of an amphiphilic compound to be added to a non-polar solvent for forming reverse vesicles depends on kinds of these, but is usually 1:5 to 1:20 as a ratio of the amphiphilic compound relative to the non-polar solvent. The reverse vesicle usually has a particle diameter of not more than 2 μm, preferably not more than 1 μm, more preferably not more than 400 nm, and particularly preferably not more than 300 nm. The smaller the particle diameter of the reverse vesicle is, the higher the stability of the reverse vesicle and the water-in-oil (W/O) emulsion of the present invention is. The smaller the HLB value of a sucrose fatty acid ester to be used is, the smaller the particle diameter of the reverse vesicle tends to be. Also, the use of an ultrasonic treatment device during the reverse vesicle formation can make the particle diameter of the reverse vesicle to be small.

The resulting reverse vesicle-containing solution can be used as an oil phase of a water-in-oil (W/O) emulsion of the present invention as it is, or may be diluted with a non-polar solvent for use as the oil phase. Also, the reverse vesicle-containing solution may be concentrated by centrifugation for use as an oil phase of a water-in-oil (W/O) emulsion of the present invention, and the concentrated solution may then be diluted with a non-polar solvent for use as the oil phase. The solvent used for dilution may be the same as the non-polar solvent used for the reverse vesicle formation, or may be another non-polar solvent as long as it does not affect stability of the reverse vesicle.

The water-in-oil (W/O) emulsion of the present invention can be prepared by adding water to the above obtained oil phase and subjecting the mixture to emulsification with an emulsification device. As the emulsification device, a known ultrasonic homogenizer and the like can be used.

An addition amount of the oil phase is not particularly limited as long as a three-phase water-in-oil (W/O) emulsion formed by emulsification effect of the above reverse vesicle can be obtained, and is usually 5-95 mass % relative to the total amount of the emulsion.

An addition amount of water is not particularly limited as long as a three-phase water-in-oil (W/O) emulsion formed by emulsification effect of the above reverse vesicle can be obtained, and is usually 5-95 mass % relative to the total amount of the emulsion.

An addition amount of an amphiphilic compound is not particularly limited as long as the three-phase water-in-oil (W/O) emulsion can be obtained, and is usually 1-10 mass % relative to the total amount of the emulsion.

### Example

Hereinafter, the present invention will be described in more detail, but the present invention is not limited to these Examples.

### Example 1

To 60 parts by mass of cyclohexane, 5 parts by mass of sucrose stearate with an HLB value of 9 (S-970 (trade name) manufactured by MITSUBISHI-KAGAKU FOODS CORPORATION) was added, and the mixture was heated at 80° C. for 2 minutes, and then shaken with a voltex mixer for 2 minutes. The mixture was again heated at 80° C. for 2 minutes, and then shaken with a voltex mixer for 2 minutes to prepare a reverse vesicle dispersing solution. Formation of reverse vesicles in this instance was confirmed by formation of doughnut-like molecular assemblies which are characteristic to vesicles and were found with differential interference contrast observation using an optical microscope, and also confirmed by maltase cross which was found with polarization microscopic observation. Further, the formation of reverse vesicles was also confirmed with a transmission electron microscope (FF-TEM) in accordance with freeze-fracturing method. Moreover, the particle diameter (average particle diameter) of reverse vesicles measured by dynamic light scattering was about 200 nm a day after the preparation, and the range of the particle diameter was 75-350 nm.

After leaving the reverse vesicle dispersing solution prepared above to stand still for a day, 35 parts by mass of an ion exchanged water was added to the dispersing solution, and the mixture was sonicated with an ultrasonic homogenizer with 20 kHz for 5 minutes for emulsification to prepare an emulsion. The resulting emulsion was a water-in-oil (W/O) type.

A viscosity of the resulting emulsion was measured using AR-G2 (TA Instruments). Also, the resulting emulsion was left to stand at room temperature, and a condition of the emulsion with lapse of time (1 hour, 1 day, 1 week and 1 month later) was visually observed, and evaluated in accordance with the following standard. Results are shown in Table 1.

### Evaluation Standard of Emulsion Condition

◯: No separation occurred.
Δ: Water drop deposition occurred but was uniformly dispersed by stirring
×: Separation occurred.

### Example 2

A reverse vesicle dispersing solution was prepared in the same manner as in Example 1 except that the amount of cyclohexane was changed to 50 parts by mass. Formation of reverse vesicles in this instance was confirmed in the same manner as in Example 1.

Then, an emulsion was prepared and evaluated in the same manner as in Example 1 except that the amount of ion exchanged water was changed to 45 parts by mass. Results are shown in Table 1.

### Example 3

A reverse vesicle dispersing solution was prepared in the same manner as in Example 1 except that the amount of cyclohexane was changed to 40 parts by mass. Formation of reverse vesicles in this instance was confirmed in the same manner as in Example 1.

Then, an emulsion was prepared and evaluated in the same manner as in Example 1 except that the amount of ion exchanged water was changed to 55 parts by mass. Results are shown in Table 1.

### Example 4

To 60 parts by mass of dodecane, 5 parts by mass of sucrose stearate with an HLB value of 9 (S-970 (trade name) manufactured by MITSUBISHI-KAGAKU FOODS CORPORATION) was added, and the mixture was heated at 80° C. for 2 minutes, and then shaken with a voltex mixer for 2 minutes. The mixture was again heated at 80° C. for 2 minutes, and then shaken with a voltex mixer for 2 minutes to prepare a reverse vesicle dispersing solution. Formation of reverse vesicles in this instance was confirmed in the same manner as in Example 1.

Then, an emulsion was prepared and evaluated in the same manner as in Example 1. Results are shown in Table 1.

### Example 5

A reverse vesicle dispersing solution was prepared in the same manner as in Example 1 except that sucrose stearate with an HLB value of 7 (S-770 (trade name) manufactured by MITSUBISHI-KAGAKU FOODS CORPORATION) was used instead of sucrose stearate with an HLB value of 9 (S-970 (trade name) manufactured by MITSUBISHI-KAGAKU FOODS CORPORATION). Formation of reverse vesicles in this instance was observed in the same manner as in Example 1.

Then, an emulsion was prepared and evaluated in the same manner as in Example 1. Results are shown in Table 1.

### Example 6

A reverse vesicle dispersing solution was prepared in the same manner as in Example 1 except that sucrose stearate with an HLB value of 11 (S-1170 (trade name) manufactured by MITSUBISHI-KAGAKU FOODS CORPORATION) was used instead of sucrose stearate with an HLB value of 9 (S-970 (trade name) manufactured by MITSUBISHI-KAGAKU FOODS CORPORATION). Formation of reverse vesicles in this instance was observed in the same manner as in Example 1.

Then, an emulsion was prepared and evaluated in the same manner as in Example 1. Results are shown in Table 1.

### Example 7

A reverse vesicle dispersing solution was prepared in the same manner as in Example 1 except that sucrose stearate with an HLB value of 15 (S-1570 (trade name) manufactured by MITSUBISHI-KAGAKU FOODS CORPORATION) was used instead of sucrose stearate with an HLB value of 9 (S-970 (trade name) manufactured by MITSUBISHI-KAGAKU FOODS CORPORATION). Formation of reverse vesicles in this instance was observed in the same manner as in Example 1.

Then, an emulsion was prepared and evaluated in the same manner as in Example 1. Results are shown in Table 1.

### Comparative Example 1

To 5 parts by mass of ethylene oxide (EO) added polyoxyethylene hydrogenated castor oil (having an average number of moles of added EO of 10) (hereinafter, referred to as HCO-10; molecular weight 1380 g/mol), 35 parts by mass of an ion exchanged water was added, and the mixture was heated at 80° C. for 2 minutes, and then shaken with a voltex mixer for 2 minutes. The mixture was again heated at 80° C. for 2 minutes, and then shaken with a voltex mixer for 2 minutes to prepare a normal vesicle dispersing solution. Formation of normal vesicles in this instance was confirmed in the same manner as in Example 1.

After leaving the normal vesicle solution prepared above to stand still for a day, 60 parts by mass of cyclohexane was added to the dispersing solution, and was sonicated with an ultrasonic homogenizer with 20 kHz for 5 minutes for emulsification to prepare an emulsion. The resulting emulsion was an oil-in-water (O/W) type.

The resulting emulsion was evaluated in the same manner as in Example 1. Results are shown in Table 1.

### Comparative Example 2

5 parts by mass of sucrose stearate with an HLB value of 3 (S-370 (trade name) manufactured by MITSUBISHI-KAGAKU FOODS CORPORATION) was dissolved in 60 parts by mass of cyclohexane.

After leaving the solution prepared above to stand still for a day, an ion exchanged water was added thereto, and the mixture was sonicated with an ultrasonic homogenizer with 20 kHz for 5 minutes for emulsification to prepare an emulsion. The resulting emulsion was a water-in-oil (W/O) type.

The resulting emulsion was evaluated in the same manner as in Example 1. Results are shown in Table 1.

### Comparative Example 3

5 parts by mass of sucrose stearate with an HLB value of 9 (S-970 (trade name) manufactured by MITSUBISHI-KAGAKU FOODS CORPORATION) was dissolved in 35 parts by mass of an ion exchanged water.

After leaving the solution prepared above to stand still for a day, cyclohexane was added thereto, and the mixture was sonicated with an ultrasonic homogenizer with 20 kHz for 5 minutes for emulsification to prepare an emulsion. The resulting emulsion was an oil-in-water (O/W) type.

The resulting emulsion was evaluated in the same manner as in Example 1. Results are shown in Table 1.

TABLE 1

| | | | Example 1 | Example 2 | Example 3 | Example 4 | Example 5 | Example 6 |
|---|---|---|---|---|---|---|---|---|
| Nonpolar | Dodecane | | | | | 60 | | |
| solvent | Cyclohexane | | 60 | 50 | 40 | | 60 | 60 |
| (part by | | | | | | | | |
| mass) | | | | | | | | |
| Amphiphilic | Sucrose | S-370 | | | | | | |
| compound | stearate | (HLB 3) | | | | | | |
| (part by | | S-770 | | | | | 5 | |
| mass) | | (HLB 7) | | | | | | |
| | | S-970 | 5 | 5 | 5 | 5 | | |
| | | (HLB 9) | | | | | | |
| | | S-1170 | | | | | | 5 |
| | | (HLB | | | | | | |
| | | 11) | | | | | | |
| | | S-1570 | | | | | | |
| | | (HLB | | | | | | |
| | | 15) | | | | | | |
| | Polyoxyethylene | HCO-10 | | | | | | |
| | hydrogenated | | | | | | | |
| | castor oil | | | | | | | |
| | derivative | | | | | | | |
| Ion exchanged water (part by mass) | | | 35 | 45 | 55 | 35 | 35 | 35 |
| Total (part by mass) | | | 100 | 100 | 100 | 100 | 100 | 100 |
| Results of | Amphiphilic compound | | Reverse | Reverse | Reverse | Reverse | Reverse | Reverse |
| evaluation | form (vesicle, reverse | | vesicle | vesicle | vesicle | vesicle | vesicle | vesicle |
| | vesicle, ordinary emulsion) | | | | | | | |
| | Particle diameter of | | 198 | 230 | 221 | 1,979 | 415 | 327 |
| | reverse vesicle or normal | | | | | | | |
| | vesicle (nm) | | | | | | | |
| | Emulsion | Few | ◯ | ◯ | ◯ | ◯ | ◯ | ◯ |
| | stability | minutes | | | | | | |
| | | 1 hour | ◯ | ◯ | ◯ | ◯ | ◯ | ◯ |
| | | 1 day | ◯ | ◯ | ◯ | Δ | Δ | ◯ |
| | | 1 week | ◯ | ◯ | ◯ | X | Δ | Δ |
| | | 1 month | ◯ | ◯ | ◯ | X | Δ | Δ |

| | | | | | | |
|---|---|---|---|---|---|---|
| Emulsion type (W/O type | W/O | W/O | W/O | W/O | W/O | W/O |
| or O/W type) | | | | | | |
| Viscosity (mPa · s) | 5.5 | 19.7 | 36.4 | 3.1 | 5.2 | 5.7 |

| | | | | Comparative | Comparative | Comparative |
|---|---|---|---|---|---|---|
| | | | Example 7 | Example 1 | Example 2 | Example 3 |
| Nonpolar | Dodecane | | | | | |
| solvent | Cyclohexane | | 60 | 60 | 60 | 60 |
| (part by | | | | | | |
| mass) | | | | | | |
| Amphiphilic | Sucrose | S-370 | | | 5 | |
| compound | stearate | (HLB 3) | | | | |
| (part by | | S-770 | | | | |
| mass) | | (HLB 7) | | | | |
| | | S-970 | | | | 5 |
| | | (HLB 9) | | | | |
| | | S-1170 | | | | |
| | | (HLB | | | | |
| | | 11) | | | | |
| | | S-1570 | 5 | | | |
| | | (HLB | | | | |
| | | 15) | | | | |
| | Polyoxyethylene | HCO-10 | | 5 | | |
| | hydrogenated | | | | | |
| | castor oil | | | | | |
| | derivative | | | | | |
| Ion exchanged water (part by mass) | | | 35 | 35 | 35 | 35 |
| Total (part by mass) | | | 100 | 100 | 100 | 100 |
| Results of | Amphiphilic compound | | Reverse | Vesicle | Ordinary | Ordinary |
| evaluation | form (vesicle, reverse | | vesicle | | emulsion | emulsion |
| | vesicle, ordinary emulsion) | | | | | |
| | Particle diameter of | | 431 | 322 | — | — |
| | reverse vesicle or normal | | | | | |
| | vesicle (nm) | | | | | |
| | Emulsion | Few | ◯ | ◯ | ◯ | ◯ |
| | stability | minutes | | | | |
| | | 1 hour | ◯ | ◯ | ◯ | X |
| | | 1 day | X | ◯ | X | X |
| | | 1 week | X | ◯ | X | X |
| | | 1 month | X | ◯ | X | X |

| | | | | |
|---|---|---|---|---|
| Emulsion type (W/O type | W/O | O/W | W/O | O/W |
| or O/W type) | | | | |
| Viscosity (mPa · s) | 5.3 | 3.7 | 6.3 | 5.0 |

From the results of Table 1, it was found that a water-in-oil (W/O) emulsion can be obtained by a three-phase emulsification method using a reverse vesicle of an amphiphilic compound as an emulsifier. It was found that the water-in-oil (W/O) emulsion was maintained stably at high water content (30-60 mass %). Also, it was found that the water-in-oil (W/O) emulsion was formed stably by using a reverse vesicle of an amphiphilic compound with an HLB value of 6-15. Further, the water-in-oil (W/O) emulsion of the present invention (Examples 1 and 4-7) was found to be low in viscosity, compared with a conventional water-in-oil (W/O) two-phase emulsion having the same ratio of the oil phase and the water phase (Comparative Example 2).

### INDUSTRIAL APPLICABILITY

The water-in-oil (W/O) emulsion of the present invention can be used for medicines, cosmetics, foods, emulsion ink and the like, and suitably used for emulsion products which require a low viscosity even with a high water content, such as an emulsion ink for inkjet printing using a line type head.

1. A water-in-oil (W/O) emulsion comprising a reverse vesicle of an amphiphilic compound as an emulsifier.

2. The water-in-oil (W/O) emulsion according to claim 1, wherein said amphiphilic compound is a sucrose fatty acid ester.

3. The water-in-oil (W/O) emulsion according to claim 2, wherein said sucrose fatty acid ester has an HLB value of 6-12.

4. The water-in-oil (W/O) emulsion according to claim 1, which has an oil phase composed of a non-polar solvent capable of maintaining said reverse vesicle stable.

5. The water-in-oil (W/O) emulsion according to claim 4, wherein said non-polar solvent is an alicyclic hydrocarbon solvent.

6. The water-in-oil (W/O) emulsion according to claim 1, wherein said reverse vesicle has a particle diameter of not more than 1 μm.
